(19) United States
(12) Patent Application Publication
(10) Pub. No.: US 2005/0038166 A1
(43) Pub. Date: Feb. 17, 2005

(54) Rubber composition

(75) Inventors: Hiroshi Fukuchi, Katsushika-ku (JP); Yoshimasa Enoki, Katsushika-ku (JP)

Correspondence Address: KODA & ANDROLIA, 2029 CENTURY PARK EAST, SUITE 1430, LOS ANGELES, CA, 90067-3024, US

(73) Assignee: Arai Seisakusho Co., Ltd.

(21) Appl. No.: 10/928,817

(22) Filed: Aug. 27, 2004

(30) Foreign Application Priority Data
Oct. 25, 2002 (JP) 2002-310855

(51) Int. Cl. C08K 3/10

(52) U.S. Cl. 524/436

(57) ABSTRACT

The present invention provides a rubber composition which shows excellent mechanical properties such as a heat resistance and a compression permanent distortion resistance. The rubber composition contains magnesium hydroxide without containing a zinc compound.

### BACKGROUND OF THE INVENTION

1. Field of the Invention

The present invention relates to a rubber which exhibits excellent mechanical properties during service in a state in which it has been immersed in a radiator solution, and particularly, to a rubber composition suitable for a packing, a O-ring, a hose and the like which are parts associated with automobiles.

2. Description of the Related Art

In general, a zinc compound represented by zinc white is incorporated in a rubber composition for the purpose of providing a heat resistance.

However, the rubber composition containing the zinc compound suffers from a problem that when it has been immersed in a radiator solution utilized for the cooling of an internal combustion engine, zinc is extracted into the radiator solution to discolor the radiator solution and settled in the form of a sediment (a slurry) to cause a failure in a machine system.

In order to solve this problem, a rubber composition has been proposed, wherein magnesium oxide is incorporated in the rubber composition in place of a zinc compound, as disclosed in, for example, Japanese Patent Application Laid-open No. 2001-247731, whereby the above-described problem is solved, and the rubber composition has a heat resistance.

However, as a result of the zealous study made by the present inventors, it has been made clear that there is another problem that among the mechanical properties of the rubber composition containing the magnesium oxide substituted for the zinc compound, the compression permanent distortion resistance is poor.

### SUMMARY OF THE INVENTION

Accordingly, it is an object of the present invention to provide a rubber composition which shows excellent mechanical properties such as a heat resistance and a compression permanent distortion resistance.

To achieve the above object, according to a first aspect and feature of the present invention, there is provided a rubber composition comprising a rubber material containing magnesium hydroxide added thereto without addition of a zinc compound.

According to the present invention, no zinc compound is contained in the rubber composition and hence, even when the rubber composition has been immersed in a radiator solution, no sediment is produced in the radiator solution. In addition, the incorporation of the magnesium hydroxide provides a heat resistance to the rubber composition and ensures that the rubber composition shows excellent mechanical properties, including an excellent compression permanent distortion resistance. Thus, the rubber composition has various effects, and for example, is suitable as a molding material for a rubber article such as a packing, an O-ring, a hose and the like, which are parts associated with automobiles.

### DETAILED DESCRIPTION OF THE INVENTION

A rubber composition according to the present invention comprises, for example, an ethylene-propylene rubber (EPDM), an acrylonitrile-butadiene rubber (NBR), or a hydrogenated acrylonitrile-butadiene rubber (HNBR), and further contains magnesium hydroxide in the rubber without containing a zinc compound.

The present invention will now be described by way of examples and comparative examples given in Table 1.

TABLE 1

| Component | Example 1 | Example 2 | Example 3 | Example 4 | Example 5 | Example 6 |
|---|---|---|---|---|---|---|
| Esprene 301A | 100 | 100 | 100 | 100 | 100 | — |
| Nipol DN407 | — | — | — | — | — | 100 |
| Zetpol 2020L | — | — | — | — | — | |
| Magnesium Hydroxide | 1 | 5 | 15 | 25 | 50 | 15 |
| Magnesium Oxide | — | — | — | — | — | — |
| Zinc White | — | — | — | — | — | — |
| Stearic Acid | 0.5 | 0.5 | 0.5 | 0.5 | 0.5 | 0.5 |
| Naugard 445 | 1 | 1 | 1 | 1 | 1 | 1 |
| Antage MB | 2 | 2 | 2 | 2 | 2 | 2 |
| Asahi 60 (FEF carbon) | 70 | 70 | 70 | 70 70 | 50 | |
| PW-380 | 15 | 15 | 15 | 15 | 15 | — |
| Plasticizer TCP | — | — | — | — | — | 15 |
| TAIC | 2 | 2 | 2 | 2 | 2 | 2 |
| Peroxymon F40 | 4 | 4 | 4 | 4 | 4 | 2 |
| Total | 195.5 | 199.5 | 209.5 | 219.5 | 244.5 | 187.5 |
| 1. Dray mechanical properties | | | | | | |
| Hardness (Hs) point | 70 | 70 | 71 | 72 | 75 | 72 |
| Tensil strength (T_{B}) MPa | 12.7 | 12.8 | 13.3 | 12.8 | 11.0 | 15.0 |
| Elongation (E₈) % | 310 | 300 | 280 | 270 | 180 | 260 |
| 2. Conpression permanent | | | | | | |
| distortion test | | | | | | |
| Sample: JIS test piece | 135° C. × 70 h | | | | | 120° C. × |
| Compressibility: 25% | | | | | | 70 h |
| Immersed in radiator solution | | | | | | |
| Rate of distortion % | 17 | 17 | 18 | 19 | 23 | 17 |
| 3. Radiator solution immersion test | | | | | | |
| 120° C. × 70 h | | | | | | |
| \mathring{1} Sediment produced or not | not produce | not produce | not produce | not produce | not produce | not produce |
| \mathring{2} Radiator solution | not produce | not produce | not produce | not produce | not produce | not produce |
| discolored or not | | | | | | |
| 4. Air heating aging test | | | | | | |
| 135° C. × 70 h | | | | | | |
| Variation in hardness point | +4 | +4 | +4 | +4 | +6 | +8 |

| | | Comparative | Comparative | Comparative |
|---|---|---|---|---|
| Component | Example 7 | Example 1 | Example 2 | Example 3 |
| Esprene 301A | — | 100 | 100 | 100 |
| Nipol DN407 | — | — | — | — |
| Zetpol 2020L | 100 | — | — | — |
| Magnesium Hydroxide | 15 | — | — | — |
| Magnesium Oxide | +113 | — | 15 | — |
| Zinc White | — | 5 | — | — |
| Stearic Acid | 0.5 | 0.5 | 0.5 | 0.5 |
| Naugard 445 | 1 | 1 | 1 | 1 |
| Antage MB | 2 | 2 | 2 | 2 |
| Asahi 60 (FEF carbon) | 50 | 70 | 70 | 70 |
| PW-380 | — | 15 | 15 | 15 |
| Plasticizer TCP | 18 | — | — | — |
| TAIC | 2 | 2 | 2 | 2 |
| Peroxymon F40 | 5 | 4 | 4 | 4 |
| Total | 193.5 | 199.5 | 209.5 | 194.5 |
| 1. Dray mechanical properties | | | | |
| Hardness (Hs) point | 72 | 70 | 73 | 70 |
| Tensil strength (T_{B}) MPa | 18.0 | 12.2 | 11.6 | 12.0 |
| Elongation (E₈) % | 300 | 230 | 210 | 300 |
| 2. Conpression permanent | | | | |
| distortion test | 150° C. × | 135° C. × 70 h | | |
| Sample: JIS test piece | 70 h | | | |
| Compressibility: 25% | | | | |
| Immersed in radiator solution | | | | |
| Rate of distortion % | 17 | 15 | 34 | 17 |
| 3. Radiator solution immersion test | | | | |
| 120° C. × 70 h | | | | |
| \mathring{1} Sediment produced or not | not produce | produce | not produce | not produce |
| \mathring{2} Radiator solution | not produce | slightly | not produce | not produce |
| discolored or not | | discolored | | |
| 4. Air heating aging test | | | | |
| 135° C. × 70 h | | | | |
| Variation in hardness point | +4 | +2 | +4 | +7 |

Table 1 shows a component, the evaluation of the dry mechanical properties, the result of the compression permanent distortion, the result of the radiator solution immersion test and the result of the air heating aging test for each of seven examples and three comparative examples.

The evaluation and the results will be described in brief.

For the dry mechanical properties, the hardness was evaluated according to JIS K 6253, and the tensile strength and the elongation were evaluated according to JIS K 6251.

The various tests will be further described. In the hardness test, a durometer for determining a hardness from a depth of depression of a push needle pushed on a test piece through a spring was used. In Table 1, Hs indicates a durometer hardness (type A) In the tensile strength test, a dumbbell-shaped test piece was pulled at a defined speed of 500±50 mm/min using a tensile tester, until it was broken, and a maximum pulling force required for such breaking was measured, whereby a tensile strength was calculated. In Table 1, T_{B} indicates a tensile strength.

In the elongation test, a maximum elongation was measured upon the breaking in the tensile strength test. In Table 1, E_{B} indicates an elongation.

The compression permanent distortion test was carried out according to JIS K 6262, and in each of Examples 1 to 5 and Comparative Examples 1 and 2, a test piece was immersed into a radiator solution having a temperature of 135° C. and retained therein for 70 hours, and a rate of distortion was evaluated after elapse of 70 hours. In Example 6, a test piece was immersed into a radiator solution having a temperature of 120° C. and retained therein for 70 hours, and a rate of distortion was evaluated after elapse of 70 hours. In Example 7, a test piece was immersed in a radiator solution having a temperature of 150° C. and retained therein for 70 hours, and a rate of distortion was evaluated after elapse of 70 hours. In any of Examples, the radiator solution used was one comprising an antifreezing solution (Honda LLC (a trade name) made by Honda Giken Kougyo, Co.) and distilled water mixed together at a ratio of 1:1 (% by volume).

The radiator solution immersion test was carried out by placing a radiator solution diluted in the same manner as that described above and 25 grams of a test piece into a settling tube having a volume of 250 cc, and retaining the settling tube for 70 hours in an oil bath of 120° C. Thereafter, the test piece was removed from the settling tube, and the settling tube containing the radiator solution remained therein was left to stand at room temperature for 24 hours. The situation of sediment produced in the radiator solution and the discoloration of the radiator solution were visually observed.

In the air heating aging test, a test piece was retained at 130° C. for 70 hours in a thermostatic chamber, and after the test piece was aged, a variation in hardness of the test piece was calculated. The variation in hardness shown in Table 1 is the result derived from the durometer hardness (type A).

### EXAMPLE 1

A rubber composition was produced by weighing the following components based on 100 parts by weight of an ethylene-propylene rubber (Esprene 301A : a trade name by Sumitomo Chemical Industries, Co.) as a rubber starting material: 1 part by weight of magnesium hydroxide (Kisuma : a trade name by Kyowa Chemical Industries, Co.), 0.5 parts by weight of stearic acid (Camellia-marked Stearic Acid: a trade name by Nippon Yushi, Co.), 1 part by weight of an antioxidant (Naugard 445: a trade name by Uniroyal Chemical, Co.), 2 parts by weight of an age resistor (Antage MB: a trade name by Kawaguchi Chemical Industries, Co.), 70 parts by weight of FEF carbon (Asahi 60: a trade name by Asahi Carbon, Co.), 15 parts by weight of a paraffinic oil (Diana Process Oil PW-380: a trade name by Idemitsu Kosan, Co.), 2 parts by weight of a co-crosslinking agent (TAIC: a trade name by Nippon Kasei, Co.) and 4 parts by weight of a crosslinking agent (Peroxymon F-40: a trade name by Nippon Yushi, Co.) (to provide a total of 195.5 parts by weight), and adding these components to the rubber starting material and kneading the resulting mixture in a well-known manner.

The evaluation of the dry mechanical properties and three tests: a compression permanent distortion test, a radiator solution immersion test and an air heating aging test were carried out as performance tests for the rubber composition in Example 1.

As a result, the dry mechanical properties of the rubber composition in Example 1 are as follows: a hardness was 70; a tensile strength was 12.7 MPa; a percent elongation was 310%; a compression permanent distortion was 17%; and a variation in hardness in the air heating aging test was +4. In the radiator solution immersion test, no sediment was produced, and a radiator solution was not discolored.

### EXAMPLE 2

A rubber composition was produced in the same manner, except that the content of magnesium hydroxide in the rubber composition in Example 1 was changed to 5 parts by weight.

The evaluation of the dry mechanical properties and three tests: a compression permanent distortion test, a radiator solution immersion test and an air heating aging test were carried out as performance tests for the rubber composition in Example 2.

As a result, the dry mechanical properties of the rubber composition in Example 2 are as follows: a hardness was 70; a tensile strength was 12.8 MPa; a percent elongation was 300%; a compression permanent distortion was 17%; and a variation in hardness in the air heating aging test was +4. In the radiator solution immersion test, no sediment was produced, and a radiator solution was not discolored.

### EXAMPLE 3

A rubber composition was produced in the same manner, except that the content of magnesium hydroxide in the rubber composition in Example 1 was changed to 15 parts by weight.

The evaluation of the dry mechanical properties and three tests: a compression permanent distortion test, a radiator solution immersion test and an air heating aging test were carried out as performance tests for the rubber composition in Example 3.

As a result, the dry mechanical properties of the rubber composition in Example 3 are as follows: a hardness was 71; a tensile strength was 13.3 MPa; a percent elongation was 280%; a compression permanent distortion was 18%; and a variation in hardness in the air heating aging test was +4. In the radiator solution immersion test, no sediment was produced, and a radiator solution was not discolored.

### EXAMPLE 4

A rubber composition was produced in the same manner, except that the content of magnesium hydroxide in the rubber composition in Example 1 was changed to 25 parts by weight.

The evaluation of the dry mechanical properties and three tests: a compression permanent distortion test, a radiator solution immersion test and an air heating aging test were carried out as performance tests for the rubber composition in Example 4.

As a result, the dry mechanical properties of the rubber composition in Example 4 are as follows: a hardness was 72; a tensile strength was 12.8 MPa; a percent elongation was 270%; a compression permanent distortion was 19%; and a variation in hardness in the air heating aging test was +4. In the radiator solution immersion test, no sediment was produced, and a radiator solution was not discolored.

### EXAMPLE 5

A rubber composition was produced in the same manner, except that the content of magnesium hydroxide in the rubber composition in Example 1 was changed to 50 parts by weight.

The evaluation of the dry mechanical properties and three tests: a compression permanent distortion test, a radiator solution immersion test and an air heating aging test were carried out as performance tests for the rubber composition in Example 5.

As a result, the dry mechanical properties of the rubber composition in Example 5 are as follows: a hardness was 75; a tensile strength was 11.0 MPa; a percent elongation was 180%; a compression permanent distortion was 23%; and a variation in hardness in the air heating aging test was +6. In the radiator solution immersion test, no sediment was produced, and a radiator solution was not discolored.

### EXAMPLE 6

A rubber composition was produced by weighing the following components based on 100 parts by weight of an acrylonitrile-butadiene rubber (Nipol DN407: a trade name by Nippon Zeon, Co.) as a rubber starting material: 15 part by weight of magnesium hydroxide (Kisuma 5A : a trade name by Kyowa Chemical Industries, Co.), 0.5 parts by weight of stearic acid (Camellia-marked Stearic Acid: a trade name by Nippon Yushi, Co.), 1 part by weight of an antioxidant (Naugard 445: a trade name by Uniroyal Chemical, Co.), 2 parts by weight of an age resistor (Antage MB: a trade name by Kawaguchi Chemical Industries, Co.), 50 parts by weight of FEF carbon (Asahi 60: a trade name by Asahi Carbon, Co.), 15 parts by weight of a plasticizer (TCP: a trade name by Ohachi Chemical Industries, Co.), 2 parts by weight of a co-crosslinking agent (TAIC: a trade name by Nippon Kasei, Co.) and 2 parts by weight of a crosslinking agent (Peroxymon F-40: a trade name by Nippon Yushi, Co.) (to provide a total of 187.5 parts by weight), and adding these components to the rubber starting material and kneading the resulting mixture in a well-known manner.

The evaluation of the dry mechanical properties and three tests: a compression permanent distortion test, a radiator solution immersion test and an air heating aging test were carried out as performance tests for the rubber composition in Example 6.

As a result, the dry mechanical properties of the rubber composition in Example 6 are as follows: a hardness was 72; a tensile strength was 15.0 MPa; a percent elongation was 260%; a compression permanent distortion was 17%; and a variation in hardness in the air heating aging test was +8. In the radiator solution immersion test, no sediment was produced, and a radiator solution was not discolored.

### EXAMPLE 7

A rubber composition was produced by weighing the following components based on 100 parts by weight of a hydrogenated acrylonitrile-butadiene rubber (Zetpol 2020L: a trade name by Nippon Zeon, Co.) as a rubber starting material: 15 part by weight of magnesium hydroxide (Kisuma 5A : a trade name by Kyowa Chemical Industries, Co.), 0.5 parts by weight of stearic acid (Camellia-marked Stearic Acid: a trade name by Nippon Yushi, Co.), 1 part by weight of an antioxidant (Naugard 445: a trade name by Uniroyal Chemical, Co.), 2 parts by weight of an age resistor (Antage MB: a trade name by Kawaguchi Chemical Industries, Co.), 50 parts by weight of FEF carbon (Asahi 60: a trade name by Asahi Carbon, Co.), 18 parts by weight of a plasticizer (TCP: a trade name by Ohachi Chemical Industries, Co.), 2 parts by weight of a co-crosslinking agent (TAIC: a trade name by Nippon Kasei, Co.) and 5 parts by weight of a crosslinking agent (Peroxymon F-40: a trade name by Nippon Yushi, Co.) (to provide a total of 193.5 parts by weight), and adding these components to the rubber starting material and kneading the resulting mixture in a well-known manner.

The evaluation of the dry mechanical properties and three tests: a compression permanent distortion test, a radiator solution immersion test and an air heating aging test were carried out as performance tests for the rubber composition in Example 7.

As a result, the dry mechanical properties of the rubber composition in Example 7 are as follows: a hardness was 72; a tensile strength was 18.0 MPa; a percent elongation was 300%; a compression permanent distortion was 17%; and a variation in hardness in the air heating aging test was +4. In the radiator solution immersion test, no sediment was produced, and a radiator solution was not discolored.

### Comparative Example 1

This comparative example was carried out to provide the evaluation and results of an experiment for the conventional rubber composition comprising a rubber material and zinc white added as a zinc compound to the rubber material.

A rubber composition was produced by weighing the following components based on 100 parts by weight of an ethylene-propylene rubber (Esprene 301A : a trade name by Sumitomo Chemical Industries, Co.) as a rubber starting material: 5 part by weight of zinc while (zinc white No.1: a trade name by Sakai Chemical Industries, Co.), 0.5 parts by weight of stearic acid (Camellia-marked Stearic Acid: a trade name by Nippon Yushi, Co.), 1 part by weight of an antioxidant (Naugard 445: a trade name by Uniroyal Chemical, Co.), 2 parts by weight of an age resistor (Antage MB: a trade name by Kawaguchi Chemical Industries, Co.), 70 parts by weight of FEF carbon (Asahi 60: a trade name by Asahi Carbon, Co.), 15 parts by weight of a paraffinic oil (Diana Process Oil PW-380: a trade name by Idemitsu Kosan, Co.), 2 parts by weight of a co-crosslinking agent (TAIC: a trade name by Nippon Kasei, Co.) and 4 parts by weight of a crosslinking agent (Peroxymon F-40: a trade name by Nippon Yushi, Co.) (to provide a total of 199.5 parts by weight), and adding these components to the rubber starting material and kneading the resulting mixture in a well-known manner.

The evaluation of the dry mechanical properties and three tests: a compression permanent distortion test, a radiator solution immersion test and an air heating aging test were carried out as performance tests for the rubber composition in Comparative Example 1.

As a result, the dry mechanical properties of the rubber composition in Comparative Example 1 are as follows: a hardness was 70; a tensile strength was 12.2 MPa; a percent elongation was 230%; a compression permanent distortion was 15%; and a variation in hardness in the air heating aging test was +2. In the radiator solution immersion test, the sediment was produced, and a radiator solution was discolored.

### Comparative Example 2

This comparative example was carried out to provide the evaluation and results of an experiment for a rubber composition according to the above-described related prior art and containing magnesium oxide added to a rubber material without addition of a zinc compound.

A rubber composition was produced by weighing the following components based on 100 parts by weight of an ethylene-propylene rubber (Esprene 301A : a trade name by Sumitomo Chemical Industries, Co.) as a rubber starting material: 15 part by weight of magnesium oxide (Kyowamag 150: a trade name by Kyowa Chemical Industries, Co.), 0.5 parts by weight of stearic acid (Camellia-marked Stearic Acid: a trade name by Nippon Yushi, Co.), 1 part by weight of an antioxidant (Naugard 445: a trade name by Uniroyal Chemical, Co.), 2 parts by weight of an age resistor (Antage MB: a trade name by Kawaguchi Chemical Industries, Co.), 70 parts by weight of FEF carbon (Asahi 60: a trade name by Asahi Carbon, Co.), 15 parts by weight of a paraffinic oil (Diana Process Oil PW-380: a trade name by Idemitsu Kosan, Co.), 2 parts by weight of a co-crosslinking agent (TAIC: a trade name by Nippon Kasei, Co.) and 4 parts by weight of a crosslinking agent (Peroxymon F-40: a trade name by Nippon Yushi, Co.) (to provide a total of 209.5 parts by weight), and adding these components to the rubber starting material and kneading the resulting mixture in a well-known manner.

The evaluation of the dry mechanical properties and three tests: a compression permanent distortion test, a radiator solution immersion test and an air heating aging test were carried out as performance tests for the rubber composition in Comparative Example 2.

As a result, the dry mechanical properties of the rubber composition in Comparative Example 2 are as follows: a hardness was 73; a tensile strength was 11.6 MPa; a percent elongation was 210%; a compression permanent distortion was 34%; and a variation in hardness in the air heating aging test was +4. In the radiator solution immersion test, no sediment was produced, and a radiator solution was not discolored.

### Comparative Example 3

This comparative example was carried out to provide the evaluation and results of an experiment for a rubber composition similar to that in the above-described Examples, except that no magnesium hydroxide was added.

A rubber composition was produced by weighing the following components based on 100 parts by weight of an ethylene-propylene rubber (Esprene 301A : a trade name by Sumitomo Chemical Industries, Co.) as a rubber starting material: 0.5 parts by weight of stearic acid (Camellia-marked Stearic Acid: a trade name by Nippon Yushi, Co.), part by weight of an antioxidant (Naugard 445: a trade name by Uniroyal Chemical, Co.), 2 parts by weight of an age resistor (Antage MB: a trade name by Kawaguchi Chemical Industries, Co.), 70 parts by weight of FEF carbon (Asahi 60: a trade name by Asahi Carbon, Co.), 15 parts by weight of a paraffinic oil (Diana Process Oil PW-380: a trade name by IdemitsuKosan, Co.), 2 parts by weight of a co-crosslinking agent (TAIC: a trade name by Nippon Kasei, Co.) and 4 parts by weight of a crosslinking agent (Peroxymon F-40: a trade name by Nippon Yushi, Co.) (to provide a total of 194.5 parts by weight), and adding these components to the rubber starting material and kneading the resulting mixture in a well-known manner.

The evaluation of the dry mechanical properties and three tests: a compression permanent distortion test, a radiator solution immersion test and an air heating aging test were carried out as performance tests for the rubber composition in Comparative Example 3.

As a result, the dry mechanical properties of the rubber composition in Comparative Example 3 are as follows: a hardness was 70; a tensile strength was 12.0 MPa; a percent elongation was 300%; a compression permanent distortion was 17%; and a variation in hardness in the air heating aging test was +7. In the radiator solution immersion test, no sediment was produced, and a radiator solution was not discolored.

As shown in the evaluation of the mechanical properties and the results of the experiments for the examples and the comparative examples, no sediment was produced and the radiator solution was not discolored in any of all the examples of the present invention. Therefore, a failure cannot be arisen in a mechanical system due to the sediment.

Further, in any of all the examples of the present invention, as can be seen by the comparison with Comparative example 2, a good numeric value is given in the compression permanent distortion test and further, the rubber composition has a heat resistance substantially approximate to that of the conventional composition (see Comparative Example 1) containing the zinc compound added in the rubber material.

The reason why the variation in hardness in the air heating aging test in Example 6 is ±8 which is larger than that in the other Examples is that it is due to the influence of the heat resistance of the rubber material which is the acrylonitrile-butadiene rubber (NBR).

In this way, it is considered that the reason why the rubber composition in any of the examples of the present invention showed the compression permanent distortion resistance more excellent than that of the rubber composition in Comparative Example 2 in the compression permanent distortion test in which the test piece was immersed in the radiator solution, is that the magnesium hydroxide added to the rubber composition is more difficult to dissolve in water than the magnesium oxide.

From the evaluation of the mechanical properties and the results of the tests in these examples and comparative examples, it has been ascertained that the particular content of the magnesium hydroxide in the rubber material according to the present invention is preferably in a range of 1 to 50 parts by weight when the amount of the rubber material is 100 parts by weight. If the content of the magnesium hydroxide is smaller than 1 part by weight, the variation in hardness in the air heating aging test is increased, resulting in a poor heat resistance (see Comparative Example 3). On the other hand, if the content of the magnesium hydroxide is larger than 50 parts by weight, the compression permanent distortion resistance tends to be poor.

In addition, if the content of the magnesium hydroxide is equal to or larger than 30 parts by weight, the compression permanent distortion resistance of the rubber composition tends to be slightly poor, as shown in the result of the compression permanent distortion test. Therefore, the content of the magnesium hydroxide in the rubber composition is preferably in a range of 5 to 30 parts by weight, when the amount of the rubber starting material is 100 parts by weight.

The rubber composition according to the present invention is not limited to those in the above-described examples, and various modifications may be made as required. For example, the rubber starting material is not limited to those described above, i.e., the ethylene-propylene rubber (EPDM), the acrylonitrile-butadiene rubber (NBR) and the hydrogenated acrylonitrile-butadiene rubber (HNBR).

1. A rubber composition, comprising a rubber material containing magnesium hydroxide added thereto without addition of a zinc compound.
